(19) United States
(12) Patent Application Publication
(10) Pub. No.: US 2024/0144017 A1
(43) Pub. Date: May 2, 2024

(54) QUANTIZATION RANGE ESTIMATION FOR QUANTIZED TRAINING

(71) Applicant: QUALCOMM Incorporated, San Diego, CA (US)

(72) Inventors: Marios FOURNARAKIS, London (GB); Markus NAGEL, Amsterdam (NL)

(21) Appl. No.: 18/548,557

(22) PCT Filed: Apr. 18, 2022
(86) PCT No.: PCT/US2022/071769

§ 371 Date: Aug. 31, 2023

(30) Foreign Application Priority Data
Apr. 16, 2021 (GR) 20210100273

(51) Int. Cl. G06N 3/084; G06N 3/0495

(52) U.S. Cl. CPC G06N 3/084; G06N 3/0495

(57) ABSTRACT

Certain aspects of the present disclosure provide techniques for efficient quantized learning. A tensor is received at a layer of a neural network, and a current tensor is generated at a first bitwidth based on the received tensor. One or more quantization parameter values are determined based on the current tensor. The current tensor is quantized to a lower bitwidth based on one or more quantization parameter values determined based on a previous tensor generated during the training of a neural network.

### CROSS-REFERENCE TO RELATED APPLICATIONS

This application claims priority to Greek Patent Application No. 20210100273, filed Apr. 16, 2021, the entire contents of which are incorporated herein by reference.

### INTRODUCTION

Aspects of the present disclosure relate to machine learning, and more specifically, to quantized training of machine learning models.

Deep Neural Networks (DNNs) have become widely used for a diverse range of applications, such as image recognition, object detection, and machine translation. However, in order to improve the accuracy and effectiveness of these networks, the size of the networks has grown considerably. Processing such large models incurs high computational cost and memory usage, which can impede the deployment of such networks to resource-constrained devices, such as smart phones, wearables, or drones, to name just a few examples.

In recent years, low-bit network quantization for neural network inference has been studied for reducing inference side comptuational complexity. However, training such models still predominately relies on full-precision floating-point formats.

Accordingly, more efficient quantized training techniques are needed.

### BRIEF SUMMARY

Certain aspects provide a method, comprising: generating a current tensor at a first bitwidth; determining one or more quantization parameter values based on the current tensor; and quantizing the current tensor to a lower bitwidth based on one or more quantization parameter values determined based on a previous tensor generated during the training of the neural network.

Certain aspects provide a method, comprising: collecting activation data statistics while generating inferences using a trained neural network; determining one or more quantization parameter values based on the activation data statistics; and using the one or more quantization parameter values during a refinement operation for the trained neural network.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow for processing data during a forward pass of a quantized machine learning model.

FIG. 2 depicts an example workflow for training a quantized machine learning model during a backwards pass.

FIG. 3 depicts an example workflow for using past statistics to inform current quantization parameters while training a machine learning model.

FIG. 4 depicts an example tensor distribution and quantization saturation to inform quantization parameters for training a machine learning model.

FIG. 5 is an example flow diagram illustrating a method for quantizing activation data during a forward pass of a machine learning model.

FIG. 6 is an example flow diagram illustrating a method for quantizing gradient data during a backward pass of a machine learning model.

FIG. 7 is an example flow diagram illustrating a method for quantized training of machine learning models.

FIG. 8 is an example flow diagram illustrating a method for generating quantization statistics during inferencing using machine learning models.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for quantized machine learning using historical tensor statistics to improve the efficiency of the training process. As used herein, training can refer to any updating or modification of a machine learning model, such as iterative training, intermittent training, continuous learning, federated learning, and the like.

Aspects of the present disclosure can be applied to forward passes of data through a network (e.g., during inferencing or during training) as well as backward passes (e.g., using back propagation during training). A wide variety of benefits are achieved by using aspects of the present disclosure to enable quantized machine learning, including reduced computational complexity for processing data, reduced power consumption, reduced latency, and the like.

Conventional efforts to quantize the training of machine learning models, such as deep neural network models, require significant memory overhead and data transfer, drastically reducing the efficiency of quantized training. Such existing approaches fail to enable training on edge devices that do not have the computational resources of servers. For example, such edge devices are often constrained or limited in terms of available power (e.g., on battery devices), memory, processor speed, availability of computatioanl elements or modules, thermal restrictions, and the like. Training on such edge devices can be desirable for a variety of reasons, including to preserve privacy and to enable personalized AI.

Quantizing data during the back-propagation process of training machine learning models (e.g., quantizing gradients) can provide considerable acceleration and power efficiency, but the noise induced by gradient quantization may be detrimental to the accuracy of the network if not controlled. In aspects of the present disclosure, with careful selection of quantization parameters, quantized training can achieve accuracy that is similar to or better than that of floating-point (FP) training in a range of tasks and models. In some aspects, this is possible by quantizing data such as the weights, weight gradients, activations, and activation gradients (e.g., to 8-bits) while maintaining certain operations, such as batch-normalization or weight updates, in floating-point (e.g., 16-bits or 32-bits).

Some aspects of the present disclosure enable efficient quantized training using defined quantization parameters (e.g., the quantization range) for gradients, activations, and/or weights. As these tensors are generally unbounded, choosing the quantization range appropriately can help keep the quantization error in check.

To define these quantization parameters in aspects of the present disclosure, the system can consider various statistical properties of the input data, including the mininum and maximum range of the data tensor, the standard deviation of the tensor, the saturation of the previous quantizations, and the like. In some aspects, the system can use a moving average of the prior tensor statistics.

In order to determine the quantization parameters for an input data tensor, conventional systems require access to the entire unquantized tensor, which is typically not available without significant data transfer and memory overhead. That is, because the tensors are generally computed portion-by-portion and the quantization range depends on the full tensor output, conventional systems require the entire high-precision tensor to be written to memory as it is generated slice-by-slice. That is, because only a portion of the tensor is generated at a time using the hardware, each portion must be written to memory succesively in order to enable analysis of the entire tensor.

By contrast, in aspects of the present disclosure, hardware-friendly quantized training is provided using hindsight-based quantization range estimation. To do so, the system can use quantization ranges estimated based on on previous training iterations in order to quantize the present tensors. Although tensors are used as an example data structure that is quantized using some aspects of the present disclosure, the quantization techniques described herein are readily applicable to any data, regardless of the particular structure or format. This approach enables fast static quantization of gradients and activations. In some aspects of the present disclosure, simple hardware support from a neural network accelerator is used to keep track of output statistics in an online fashion. Further, this allows a processing system to use pre-computed quantization ranges to significantly accelerate computation and to reduce the memory overhead. In some aspects, a moving average of the quantization range can be used, and the range can be updated based on statistics extracted from the accumulator in an efficient and online fashion.

The quantization techniques discussed herein can be applied to enable fully quantized training (during both forward and backward passes) of machine learning models, such as deep neural networks. Aspects can also be applied to inferencing using deep neural networks, to enable fast and efficient execution. This can enable improved machine learning (e.g., training and inferencing with reduced computational expense) even on resource-constrained devices.

For example, during quantized training, tensor statistics from earlier training iterations can be used when quantizing tensors during current and/or subsequent iterations. In some aspects, once the model is trained, statistics can be collected for activation tensors generated during inferencing. During a subsequent training or refinement operation, these statistics can then be used to determine appropriate quantization parameters when quantizing the activation tensors that are generated during forward passes of training data.

### Example Quantized Training during a Forward Pass

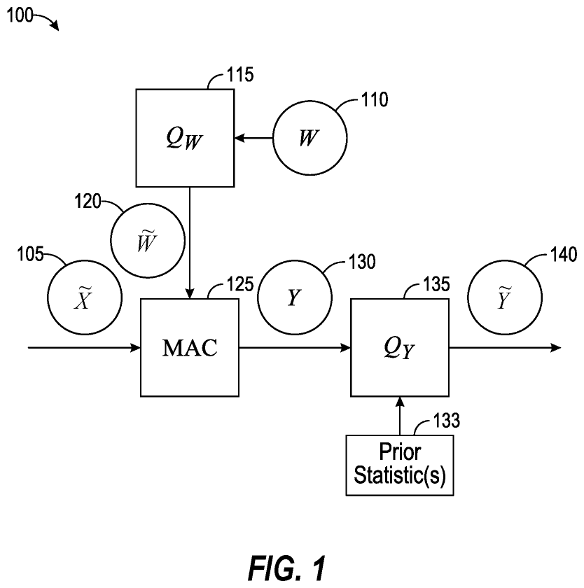

FIG. 1 depicts an example workflow 100 for processing data during a forward pass of a quantized machine learning model.

In aspects of the present disclosure, neural network training can generally be thought of as a series of iterations or steps, where each iteration includes a forward pass and a backwards pass. The forward pass refers to the process where data is passed from the start of the network through to the end, traversing through each neuron and layer. A loss can then be computed, and a backwards pass (e.g., back propagation) is used to refine the weights or other parameters of the model (beginning at the last layer, and moving towards the first). In some aspects, a “forward pass” may also refer to processing input data during inferencing.

In the illustrated workflow 100, quantized input 105 is received at a layer in the model. This input may be in the form of a tensor received from a prior layer in the model (or as direct input to the model in the case of the first layer). In some aspects, the input 105 is referred to as activation data or an activation tensor. That is, the input 105 may be activation data from a prior layer. As used herein, data is “activation data” if it has been processed using an activation function (e.g., in the prior layer), and “pre-activation data” when it has not yet been processed with an activation function (e.g., in the current layer). Though the illustrated example depicts the input 105 as quantized, in some aspects, this input 105 may be full precision.

Weights 110 for the layer can be stored in a high precision format (e.g., 16 or 32-bit floating point) to allow the accumulation of small gradients during training. For the forward pass, the weight tensor is quantized to a lower-bit weight tensor 120 through weight quantization function 115. This reduces the computational expense of using the weights during the forward pass.

During the workflow 100, the quantized weight tensor 120 can then be provided to a multiply and accumulate (MAC) array 125, along with the quantized input 105. The MAC array is generally a hardware or software component configured to perform multiply and accumulate operations, where each value in two tensors are multiplied together and added to a running sum via an accumulator. For example, the MAC array may compute the dot product or inner product of the input tensors. The MAC array 125 can then compute the linear operations of the layer in traditional fashion, resulting in tensor 130.

Generally, as the quantized input tensor 105 and the quantized weights 120 are typically larger than the MAC array 125, the output tensor 130 is calculated over multiple compute cycles. The output tensor 130 can then be followed by a quantization operation 135 to covert it to a desired bit-width. For example, the output tensor 130 may be 32-bits, and the quantized output tensor 140 may be 8-bits.

As illustrated, to perform the quantization operation 135, the system can use prior statistics 133. These statistics reflect the characteristics of the output tensor 130 during one or more prior iterations of the training process. That is, rather than evaluating the current statistics of the current output tensor 130 in order to define the quantization parameters for the current iteration, the system can use prior statistics 133 for output tensors generated during one or more prior iterations.

In some aspects, an activation function can be applied to the output tensor 130 before quantization operation 135, or to the quantized tensor output 140 after the quantization operation 135, or both. That is, depending on the complexity of the activation function, the system may apply the activation function before the quantization operation 135, after the quantization operation 135, or both before and after. For example, a rectified linear unit (ReLU) activation may be applied after the quantization, while other more complex activation functions need to be applied both before and after the quantization.

As discussed above, dynamic quantization techniques rely on the statistics of a full-precision tensor to quantize the tensor. For example, to perform the quantization operation 115, the statistics of the weight tensor 110 (e.g., the minimum and maximum of the weight tensor 110, which can be used to define the quantization range of the quantization operation 115) must be known. In the case of static quantization, the quantization ranges are known in advance. For example, as the weights are known, the statistics of the weights 110 may also be pre-computed, allowing the quantization operation 115 to be performed efficiently.

However, for the quanitzation operation 135, the statistics of the output tensor 130 are unknown until the tensor itself is computed. Generally, the size of the input tensor 105 and weight tensor 120 that are multiplied in the MAC array 125 exceed the size of the array. For this reason, the computation takes places in slices until the whole tensor multiplication is completed. The output of the the accumulator is typically in a higher bit-width (e.g., 32-bits) to avoid overflow. That is, because the accumulator can often accumulate large sums (that can easily exceed the maximum value that is representable using the number of bits available in the input data), the output is typically higher bitwidth to ensure that the accumulated value does not overflow the smaller bitwidth.

To extract the necessary statistics in existing or traditional systems, all the outputs of the MAC array 125 or the accumulator associated with the MAC array 125 (e.g., all portions of the output tensor 130) must first be written to memory. In existing systems, after the full tensor is available, the statistics can be extracted and the quantization range can be calculated. Existing systems must then bring the output tensor 130 back to the compute unit (from memory) to be quantized using these parameters, and then stored back in memory.

These existing approaches lead to significant memory overhead and extra data movement. Aspects of the present disclosure therefore use the statistics from prior iterations in order to control the current quantization. This allows the parameters to be pre-computed, enabling efficient performance of the quantization operation 135.

To do so, during a current training iteration, the system can efficiently extract statistics from the output tensor 130 as it is generated (e.g., without requiring it be written to memory). For example, as each portion of the tensor is generated, the system can identify the minimum and maximum values of the portion. The portion can then be quantized using quantization operation 135 based on quantization parameters that were determined during one or more prior iterations.

When the entire tensor has been generated and evaluated, the overall minimum and maximum values of the tensor 130 during the current iteration can be used to set the quantization range for the next training iteration. During a subsequent iteration, these ranges are used to perform the quantization operation 135 (while updated statistics are collected for subsequent iterations).

That is, during a first training iteration, a first set of statistics are used to determine a first set of quantization parameters. During a second (subsequent) training iteration, the first set of quantization parameters are used to quantize the tensor, while a second set of tensors statistics are used to determine a second set of quantization parameters (e.g., by refining the first set of quantization parameters based on a moving average). During a third training iteration (subsequent of the second iteration), this second set of quantization parameters is used to quantize the data. This approach allows the quantization operations to be performed efficiently, both in terms of improved memory overhead and memory transfer, as well as in reduced power consumption and latency.

When data is first passed through the model during the forward pass (e.g., during the first training iteration), quantization parameters may be unavailable (as there are no prior iterations or statistics). In some aspects, therefore, the system can perform traditional dynamic quantization (e.g., writing the output tensor 130 to memory in order to evaluate it in its entirety, and using these values to perform the first quantization operation 135). Subsequent iterations can use the hindsight-based techniques described herein. In other aspects, the quantization parameters for this first round may be determined using other techniques, such as randomly or psuedo-randomly, based on heuristics, and the like.

### Example Quantized Training During a Backward Pass

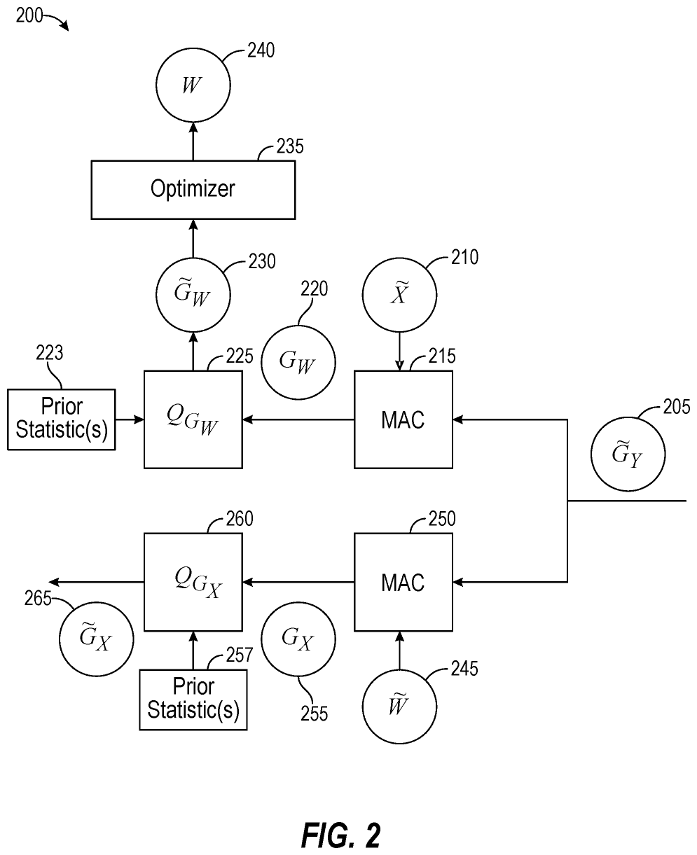

FIG. 2 depicts an example workflow 200 for training a quantized machine learning model during a backwards pass.

During the backward pass, a quantized activation gradient 205 is used to calculate the weight gradient 220 and input gradient 255. Specifically, a MAC array 215 is used to compute the weight gradient 220 based on the quantized activation gradient 205 and a quantized input tensor 210. In some aspects, the quantized input tensor 210 corresponds to the quantized input tensor 105 that was used, during the forward pass.

In some aspects, the weight gradient 220 can be quantized to a lower-bit representation (e.g., quantized weight gradient 230) using quantization operation 225. In other aspects, the weight gradient 220 can be kept in full-precision. In the illustrated workflow 200, the quantized weight gradient 230 is used by an optimizer 235 to refine the weights 240 for the layer.

In a similar manner to the quantization operation 135 discussed above with reference to FIG. 1, the quantization operation 225 may be performed using quantization parameters that are determined based on the statistics of the weight gradient 220 in prior iterations (e.g., prior statistics 223). That is, the current statistics of the weight gradient 220 can be collected for future iterations, while the previous statistics are used to perform the current quantization operation 225.

In the illustrated workflow 200, the input gradient 255 is also computed by a MAC array 250 based on the quantized activation gradient 205 and quantized weight tensor 245. As the input gradient 255 may be quite large, it can be quantized using the quantization operation 260 to a lower-bit representation (e.g., quantized input tensor 265) before it is propagated to the preceding layer.

In a similar manner to the quantization operation 135 discussed above with reference to FIG. 1 and the quantization operation 225, the quantizatioin operation 260 may be performed using quantization parameters that are determined based on the statistics of the input gradient 255 from prior iterations (e.g., prior statistics 257). That is, the current statistics of the input gradient 255 can be collected for future iterations, while the previous statistics are used to perform the current quantization operation 260.

As discussed above, this use of historical statistics from prior iterations can enable the quantization operations 225 and 260 to be performed efficiently, reducing memory and computational overhead, as well as power consumption and latency.

When data is first passed through the model during the backward pass (e.g., during the first training iteration), quantization parameters may be unavailable (as there are no prior iterations or statistics). In some aspects, therefore, the system can perform traditional dynamic quantization (e.g., writing the weight gradient 220 and/or input gradient 255 to memory in order to evaluate it in its entirety, and using these values to perform the first quantization operation 225 and 260). Subsequent iterations can use the hindsight-based techniques described herein (and illustrated via prior statistics 223 and 257). In other aspects, the quantization parameters for this first round may be determined using other techniques, such as randomly or psuedo-randomly, based on heuristics, and the like.

### Example Quantization Parameter Determination for Quantized Training

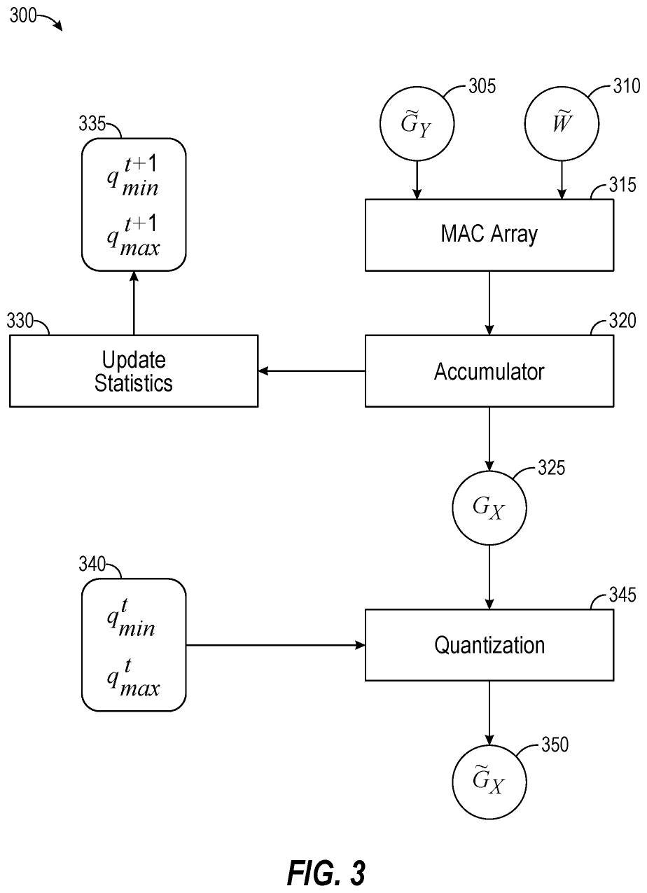

FIG. 3 depicts an example workflow 300 for using past statistics to inform current quantization parameters while training a machine learning model. Although the illustrated workflow 300 uses gradient quantization during a backward pass as an example, aspects of the present disclosure are readily applicable to any data that is quantized during machine learning, including activation quantization, weight quantization, and the like.

In the illustrated workflow 300, quantized activation gradients 305 and a quantized weight tensor 310 are processed using a MAC array 315. In some aspects, the quantized activation gradients 305 and quantized weight tensor 310 correspond to the quantized activation gradient 205 and quantized weight tensor 245 discussed above with reference to FIG. 2.

The MAC array 315, in conjunction with an accumulator 320 (which may be a discrete component, or may be part of the MAC array 315) generate an input gradient 325 based on the quantized activation gradient 305 and quantized weight tensor 310. The accumulator generally accumulates the sum of the products calculated by the MAC array 315. As illustrated, statistics of the input gradient 325 are collected and output by the accumulator 320 to block 330, which generates or updates a set of quantization parameters 335. For example, as the accumulator 320 outputs portions of the input gradient 325, the system can determine the minimum value, maximum value, standard deviation of values, and the like of (portion of) the input gradient 325. In the illustrated aspect, the quantization parameters 335 are a minimum and maximum quantization value (e.g., a quantization range). In one aspect, the system can set the minimum and maximum quantization values equal to the minimum and maximum tensor values for the current tensor.

As illustrated, during the current iteration at time t, the current set of quantization parameters 335 are determined based on the statistics of the current input gradient 325. As illustrated, these quantization parameters 335, although determined at time t based on the current tensor, will be used to quantize the input gradient during the subsequent iteration at t+1. While the MAC output (the input gradient 325) is computed, the system keeps track of, for example, the min-max statistics from the accumulator 320. Other statistics may be used in other examples. These statistics are then used to update the quantization ranges as soon as the complete tensor has been calculated (e.g., once the last portion of the tensor is generated). For example, the block 330 may keep track of the lowest value and highest value that has been seen in any completed portion of the tensor. When the tensor is complete, the block 330 may use these values as the quantization parameters 335.

Further, to quantize the current tensor at the current t^{th} iteration, the system uses the quantization ranges determined from one or more previous iterations. As illustrated, during this t^{th} iteration, the system performs quantization 345 using quantization parameters 340 (labeled q^{t}, although they were collected at time t−1) to generate a quantized input gradient 350, which is propogated to the preceding layer of the model. The quantization parameters 340 are defined based at least in part on one or more prior iterations. As illustrated, the quantization parameters 340 used for the quantization 345 at the current iteration are not defined based on the current tensor statistics. That is, the quantization parameters 340 are defined only based on statistics from one or more prior iterations, as the current statistics of the input gradient 325 may be unknown until after the quantization 345 has begun.

In some aspects, the quantization parameters 335 are defined as the minimum and maximum of the input gradient 325 (as in the depicted example). In other aspects, the quantization parameters are defined as a moving average of the parameter values. For example, in one such aspect, the quantization parameters used at time t (and collected at time t−1), defined as q^{t}, are defined using Equation 1 below, where η is a momentum term, G^{t-1} is the input gradient 325 at time t−1, q^{t-1} is the quantization parameters at time t−1, and stat(·) is a statistical operation (e.g., minimum value, maximum value, and the like).

q^{t}=(1−η)stat(G^{t-1})+ηq^{t-1} (1)

For example, the minimum and maximum values of the quantization range at time t (qₘᵢₙ^{t} and qₘₐₓ^{t}, respectively), may be defined as:

qₘᵢₙ=(1−ƒ)min(G^{t-1})+ηqₘᵢₙ^{t-1}and qₘₐₓ^{t}=(1−η)max(G^{t-1})+μqₘₐₓ^{t-1}.

In some aspects, during the first iteration (at time t=0), the set of quantization parameters q⁰ can be defined as stat(G⁰), as discussed above. That is, during the first iteration, the statistics of the current tensor can be used to define the quantization parameters. During subsequent iterations, the statistics of one or more prior tensors are used to define the quantization parameters.

### Example Quantization Parameter Update based on Quantization Saturation

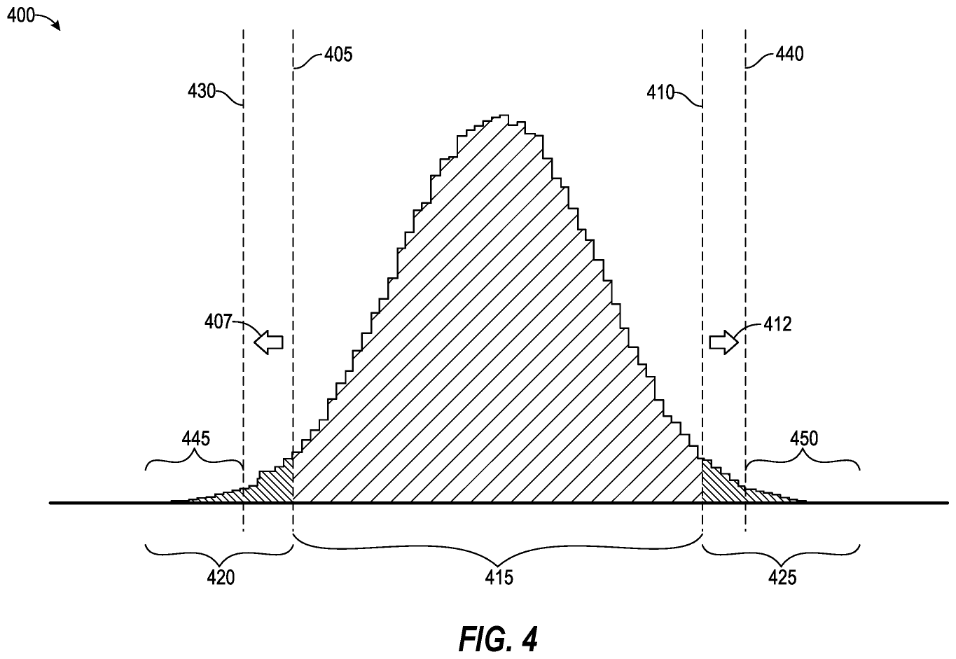

FIG. 4 depicts an example tensor distribution 400 and quantization saturation to inform quantization parameters for training a machine learning model.

The distribution 400 illustrates a distribution of values in a tensor (e.g., a tensor of gradients). In the illustrated distribution 400, different data values are mapped to the horizontal axis, and the number of times that data value is present in the tensor is reflected via the vertical axis. Thus, for example, values near the middle of the distribution are represented frequently in the tensor, while values near either extreme are not reflected in the tensor as often. The tensor values may generally form a roughly normal distribution in some aspects. In the illustrated aspect, a quantization range has been defined using a minimum value (indicated by line 405) and a maximum value (indicated by line 410). That is, when the tensor is quantized, values in the range 415 are within the quantization range, while values outside this range (in ranges 420 and 425) are clipped. These values in ranges 420 and 425 may be referred to as saturated.

The saturation ratio α can be defined as the proportion of values that are clipped during a quantization operation. In one aspect, the saturation ratio is defined using Equation 2 below, where G is the tensor, qₘᵢₙ is the minimum of the quantization range, qₘₐₓ is the maximum of the quantization range, and |·| represents the number of elements in the tensor.

$$α = \frac{\vert G < {q}_{min} \vert + \vert G > {q}_{max} \vert}{\vert G \vert} \qquad ( 2 )$$

In some aspects, this saturation ratio can be used to define the quantization range for subsequent iterations. For example, in one aspect, if the saturation ratio for the current iteration is within an acceptable range defined by a minimum and maximum saturation threshold (e.g., saturation ratio Cₘᵢₙ or αₘᵢₙ and Cₘₐₓ or αₘₐₓ), then the quantization range is not changed or updated. If these limits are exceeded, then the quantization ranges for the next iteration can be updated. In one such aspect, the quantization range can be updated according to qₜ=λqₜ. λ can be defined using Equation 3 below, where CDF⁻¹ is an inverse cumulative distribution function, α is the saturation ratio, and step is a defined step value. The step value may be a defined value (e.g., a hyperparameter) used to increase or decrease the saturation ratio.

$$λ = \{ \begin{matrix}{C}_{max} / {CDF}^{- 1} [ 1 - \frac{α}{2} ] & if α > {C}_{max} \\ 1 & if {C}_{min} < α \leq {C}_{max} \\ 1 - step & if α \leq {C}_{min}\end{matrix} \qquad ( 3 )$$

In at least one aspect, rather than updating the quantization range each time the saturation ratio falls outside of the defined saturation range, the quantization range is only updated when the saturation ratio falls outside of this range consistently (e.g., for at least τ iterations).

In the illustrated example, the system has updated the quantization range (indicated by arrows 407 and 412) to a new minimum and maximum value (indicated by lines 430 and 440, respectively) for subsequent quantizations. This results in a smaller portion (indicated by ranges 445 and 450) of the tensor being clipped.

### Example Method for Quantizing Activation Data during a Forward Pass of a Quantized Machine Learning Model

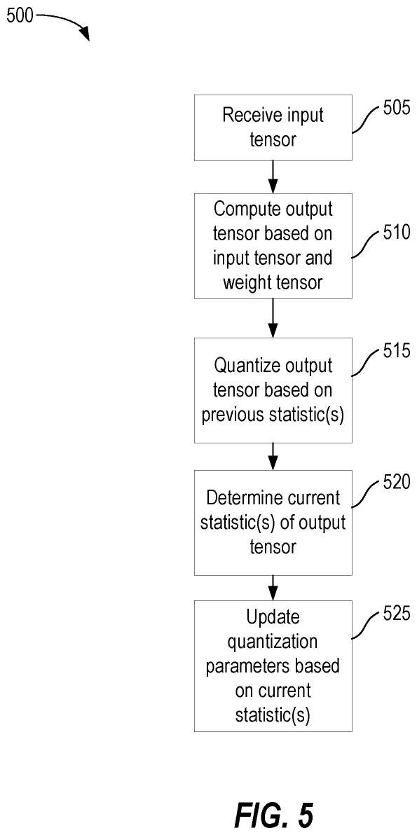

FIG. 5 is an example flow diagram illustrating a method 500 for quantizing activation data during a forward pass of a machine learning model.

The method 500 begins at block 505, where an input tensor is received. For example, an activation tensor (which may or may not be quantized) can be received from a prior layer in the model. In at least one aspect, the received input tensor can correspond to the quantized input tensor 105 discussed with reference to FIG. 1.

At block 510, an output tensor is computed based on the received input tensor and a weight tensor. For example, as illustrated in FIG. 1, an output tensor 130 (which may be pre-activation data or activation data) can be computed by multiplying the input tensor and the weight tensor. In some aspects, this output tensor is computed at a relatively large bitwidth (e.g., 32 bits) using a fixed point format. In an aspect, to improve the efficiency of the training process, the output tensor can therefore be quantized to a lower bitwidth.

At block 515, the output tensor is quantized based on one or more previous statistics for the layer. For example, as discussed above, statistics or characteristics of the output tensor during one or more prior iterations can be collected and evaluated to generate quantization parameters (e.g., a quantization range) for the current quantization. Notably, the statistics or characteristics of the current output tensor are not considered when determining the quantization parameters for the current iteration. That is, the current output tensor is quantized based only on prior statistics, and is not evaluated or analyzed to determine the current quantization parameters. However, the current statistics of the current tensor can be used to update the quantization parameters that will be used in one or more subsequent iterations.

In some aspects, portions of the output tensor are generated individually. Because the system defines the quantization parameters based on prior iterations, however, these portions can be individually quantized immediately (rather than waiting for the entire tensor to be generated).

At block 520, the statistics of the current output tensor (generated at block 510) are determined. This may include, for example, determining the minimum and/or maximum values of the tensor. In some aspects, the standard deviation of the current tensor is determined. In at least one aspect, the saturation ratio of the current quantization (performed at block 515) is determined.

At block 525, the quantization parameters are updated based on the current statistics (determined at block 520). These updated quantization parameters can then be used in one or more subsequent iterations.

In some aspects, the quantization parameters are updated using a moving average of prior parameters. For example, the minimum and/or maximum values of the quantization range can be updated using Equation 1, above. As another example, the minimum and/or maximum values of the quantization range can be updated based on the saturation ratio using Equation 3, above.

These updated quantization parameters can then be used in a subsequent training iteration.

### Example Method for Quantizing Gradient Data during a Backward Pass of a Quantized Machine Learning Model

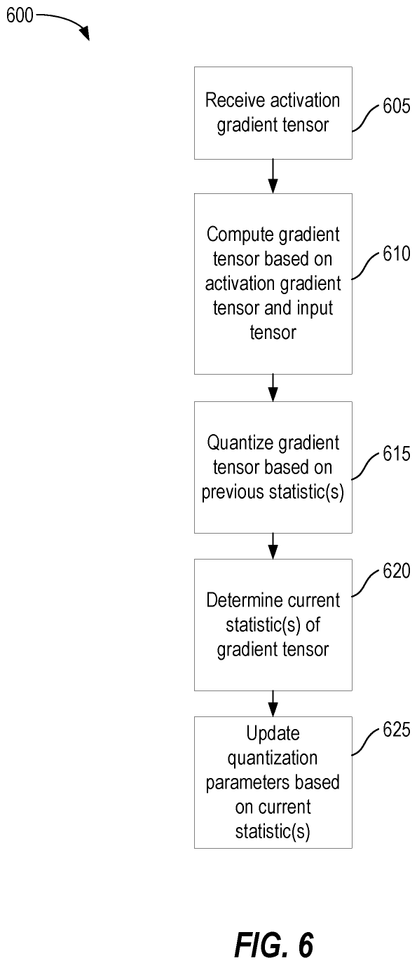

FIG. 6 is an example flow diagram illustrating a method 600 for quantizing gradient data during a backward pass of a machine learning model.

The method 600 begins at block 605, where a tensor of activation gradients is received. For example, the activation gradient tensor (which may or may not be quantized) can be received from a subsequent layer in the model during back-propagation. In at least one aspect, the received activation gradient tensor can correspond to the activation gradient 205 discussed with reference to FIG. 2.

At block 610, a gradient tensor is computed based on the received activation gradient tensor and a weight tensor. In some aspects, this gradient tensor may be an input gradient tensor or a tensor of weight gradients. For example, as illustrated in FIG. 2, an input gradient 255 can be computed by multiplying the activation gradient tensor and the weight tensor. Similarly, as illustrated in FIG. 2, a weight gradient 220 can be computed by multiplying the activation gradient tensor 205 and the input tensor 210.

In some aspects, this gradient tensor is computed at a relatively large bitwidth (e.g., 32 bits) using a fixed point format. In an aspect, to improve the efficiency of the training process, the input tensor can therefore be quantized to a lower bitwidth. In some aspects, if the gradient tensor is a weight gradient tensor, the weight gradient tensor may be maintained at the high bitwidth rather than quantizing it.

At block 615, the gradient tensor is quantized based on one or more previous statistics for the layer. For example, as discussed above, statistics or characteristics of the gradient tensor during one or more prior iterations can be collected and evaluated to generate quantization parameters (e.g., a quantization range) for the current quantization. Notably, the statistics or characteristics of the current gradient tensor are not considered when determining the quantization parameters for the current iteration. That is, the current gradient tensor is quantized based only on prior statistics, and is not evaluated or analyzed to determine the current quantization parameters. The current statistics of the current gradient tensor can be used to update the quantization parameters that will be used in one or more subsequent iterations.

In some aspects, portions of the gradient tensor are generated individually. Because the system defines the quantization parameters based on prior iterations, however, these portions can be individually quantized immediately (rather than waiting for the entire tensor to be generated).

At block 620, the statistics of the current gradient tensor (generated at block 610) are determined. This may include, for example, determining the minimum and/or maximum values of the tensor. In some aspects, the standard deviation of the current tensor is determined. In at least one aspect, the saturation ratio of the current quantization (performed at block 615) is determined.

At block 625, the quantization parameters are updated based on the current statistics (determined at block 620). These updated quantization parameters can then be used in one or more subsequent iterations.

In some aspects, the quantization parameters are updated using a moving average of prior parameters. For example, the minimum and/or maximum values of the quantization range can be updated using Equation 1, above. As another example, the minimum and/or maximum values of the quantization range can be updated based on the saturation ratio using Equation 3, above.

These updated quantization parameters can then be used in a subsequent training iteration.

### Example Method for Quantized Training of Machine Learning Models

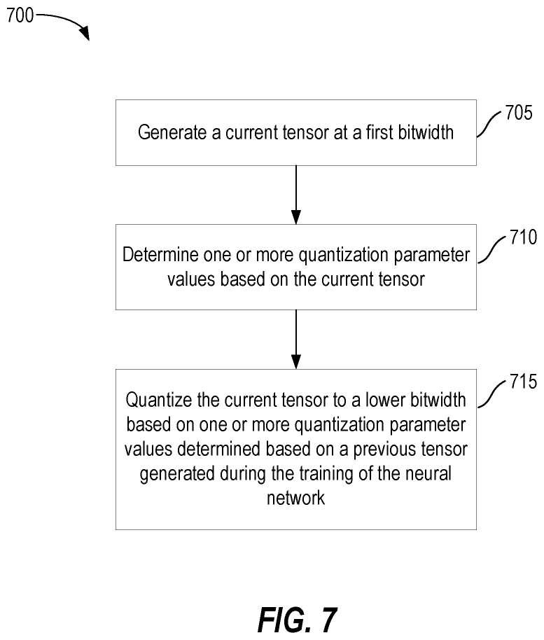

FIG. 7 is an example flow diagram illustrating a method 700 for quantized training of machine learning models.

The method 700 begins at block 705, where a current tensor is generated at a first bitwidth. In some aspects, the current tensor is a gradient tensor. In some aspects, the current tensor is an activation tensor. In some aspects, the current tensor is generated based on a tensor received at a layer of a neural network.

At block 710, one or more quantization parameter values are determined based on the current tensor. In some aspects, the one or more quantization parameter values determined based on the current tensor are computed based on a minimum current tensor value and a maximum current tensor value. In some aspects, the one or more quantization parameter values determined based on the current tensor are computed based on a standard deviation of current tensor values.

In some aspects, determining the one or more quantization parameter values based on the current tensor comprises determining a moving average of the one or more quantization parameter values based on the current tensor and the previous tensor.

In some aspects, a current minimum quantization parameter value qₘᵢₙ^{t} is calculated as a moving average based on the previous tensor T^{t-1} and a previous minimum quantization parameter value qₘᵢₙ^{t-1}, according to qₘᵢₙ^{t}=(1−η)min(T^{t-1})+ηqₘᵢₙ^{t-1}, and a current maximum quantization parameter value gₘₐₓ^{t} is calculated as a moving average based on the previous tensor T^{t-1} and a previous maximum quantization parameter value qₘₐₓ^{t-1}, according to qₘₐₓ^{t}=(1−η)max(T^{t-1})+ηqₘₐₓ^{t-1}, wherein η is a momentum parameter.

In some aspects, the one or more quantization parameter values determined based on the current tensor comprise a quantization range computed based on a saturation ratio for quantizing the current tensor.

In some aspects, quantization range is updated based on one or more thresholds associated with the saturation ratio.

In some aspects, the one or more thresholds comprise a maximum saturation threshold Cₘₐₓ and a minimum saturation threshold Cₘᵢₙ, the quantization range is defined by a current quantization parameter value qₜ, and updating the quantization range is performed according to:

$${q}_{t} = λ {q}_{t} ; where λ = \{ \begin{matrix}{C}_{max} / {CDF}^{- 1} [ 1 - \frac{α}{2} ] & if α > {C}_{max} \\ 1 & if {C}_{min} < α \leq {C}_{max} \\ 1 - step & if α \leq {C}_{min}\end{matrix}$$

where CDF⁻¹ is an inverse cumulative distribution function, α is the saturation ratio, and step is a defined step value.

In some aspects, the method 700 further comprises storing the one or more quantization parameter values determined based on the current tensor in a memory for use in a subsequent tensor quantization, and quantizing a subsequent tensor during a subsequent pass of data through the layer of the neural network based on the one or more quantization parameter values determined based on the current tensor.

At block 715, the current tensor is quantized to a lower bitwidth based on one or more quantization parameter values determined based on a previous tensor generated during the training of the neural network. In some aspects, using the one or more quantization parameters determined based on the previous tensor reduces memory transfer needed to quantize the current tensor.

### Example Method for Generating Quantization Statistics During Inferencing using Machine Learning Models

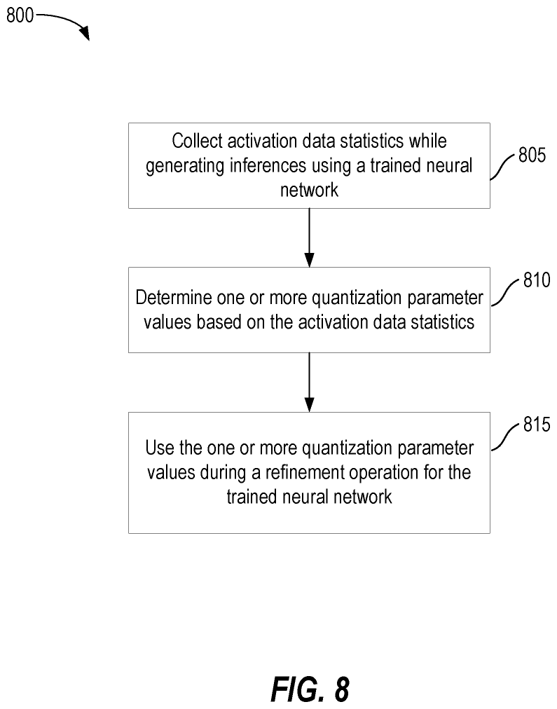

FIG. 8 is an example flow diagram illustrating a method 800 for generating quantization statistics during inferencing using machine learning models.

The method 800 begins at block 805, where activation data statistics are collected while generating inferences using a trained neural network.

At block 810, one or more quantization parameter values are determined based on the activation data statistics.

In some aspects, the one or more quantization parameter values determined based on the activation data statistics are computed based on a minimum value and a maximum value of the activation data.

In some aspects, the one or more quantization parameter values determined based on the activation data statistics are computed based on a standard deviation of the activation data.

In some aspects, the one or more quantization parameter values determined based on the activation data statistics comprise a quantization range computed based on a saturation ratio for quantizing the activation data.

In some aspects, the quantization range is updated based on one or more thresholds associated with the saturation ratio.

At block 815, the one or more quantization parameter values are used during a refinement operation for the trained neural network.

In some aspects, the method 800 further comprises, during the refinement operation: generating a current tensor at a first bitwidth; determining one or more quantization parameter values based on the current tensor; and quantizing the current tensor to a lower bitwidth based on the one or more quantization parameter values determined based on the activation data statistics.

### Example Processing System for Quantized Training

In some aspects, the techniques, methods, and workflows described with reference to FIGS. 1-8 may be implemented on one or more devices or systems.

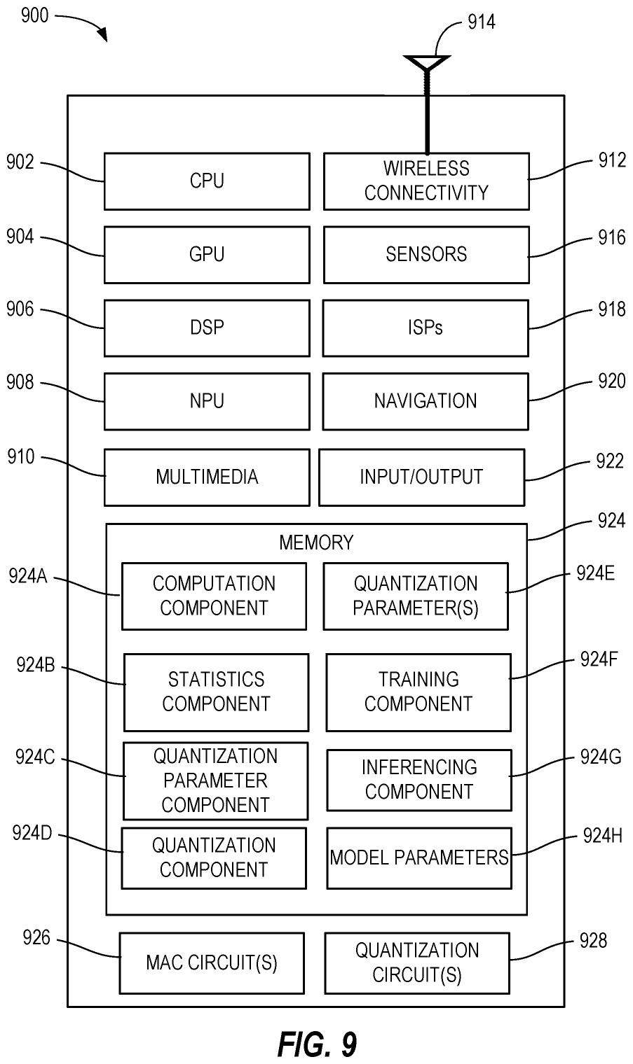

FIG. 9 depicts an example processing system 900 which may be configured to perform aspects of the various methods described herein, including, for example, the aspects described with respect to FIGS. 1-9.

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as 908, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes a computation component 924A, a statistics component 924B, a quantization parameter component 924C, a quantization component 924D, a set of quantization parameters 924E, a training component 924F, an inferencing component 924G, and a set of model parameters 924H. These components may be configured according to one or more aspects described herein.

For example, the computation component 924A may be configured to generate activation tensors, gradient tensors, weight tensors, and the like during training and/or inferencing (e.g., using MAC circuit(s) 926).

The statistics component 924B may be configured to extract statistics from the generated tensors, such as the minimum value, maximum value, standard deviation, quantization saturation ratio, and the like.

The quantization parameter component 924C may be configured to update the quantization parameters 924E based on the current statistics at each iteration of the training process.

The quantization component 924D may be configured to quantize the generated tensors based on the quantization parameters 924E, which were generated or updated based on prior training iterations.

The training component 924F and inferencing component 924G may generally be configured to train one or more models (e.g., to refine the set of model parameters 924H) and to generate inferences using the models (e.g., using the trained model parameters 924H), respectively. For example, the training component 924F and inferencing component 924G may train and use quantized machine learning techniques, such as those illustrated in FIGS. 1-8.

The set of model parameters 924H can generally include parameters for one or more machine learning models (e.g., neural networks), including quantized models discussed herein.

Processing system 900 further comprises one or more MAC circuit(s) 926 and a quantization circuit(s) 928, which may be configured to perform multiply-accumulate operations and quantization operations, respectively, via hardware.

Though depicted as a separate circuit for clarity in FIG. 9, the MAC circuit(s) 926 and quantization circuit(s) 928 may be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia component 910, wireless connectivity 912, sensors 916, ISPs 918, and/or navigation component 920 may be omitted in other aspects. Further, aspects of processing system 900 maybe distributed between multiple devices.

The depicted components, and others not depicted, may be configured to perform various aspects of the methods described herein.

### Example Clauses

Clause 1: A method for training a neural network model, comprising: receiving a tensor at a layer of the neural network; generating a current tensor at a first bitwidth based on the received tensor; determining one or more quantization parameter values based on the current tensor; and quantizing the current tensor to a lower bitwidth based on one or more quantization parameter values determined based on a previous tensor generated during the training of the neural network, wherein using the one or more quantization parameters determined based on the previous tensor reduces memory transfer needed to quantize the current tensor.

Clause 2: A method according to Clause 1, wherein the one or more quantization parameter values determined based on the current tensor are computed based on a minimum current tensor value and a maximum current tensor value.

Clause 3: A method according to any one of Clauses 1-2, wherein the one or more quantization parameter values determined based on the current tensor are computed based on a standard deviation of current tensor values.

Clause 4: A method according to any one of Clauses 1-3, further comprising: storing the one or more quantization parameter values determined based on the current tensor in a memory for use in a subsequent tensor quantization; and quantizing a subsequent tensor during a subsequent pass of data through the layer of the neural network based on the one or more quantization parameter values determined based on the current tensor.

Clause 5: A method according to any one of Clauses 1-4, wherein determining the one or more quantization parameter values based on the current tensor comprises determining a moving average of the one or more quantization parameter values based on the current tensor and the previous tensor.

Clause 6: A method according to any one of Clauses 1-5, wherein: a current minimum quantization parameter value qₘᵢₙ^{t} is calculated as a moving average based on the previous tensor T^{t-1} and a previous minimum quantization parameter value qₘᵢₙ^{t-1}, according to qₘᵢₙ^{t}=(1−η)min(T^{t-1})+ηqₘᵢₙ^{t-1}, and a current maximum quantization parameter value qₘₐₓ^{t} is calculated as a moving average based on the previous tensor T^{t-1} and a previous maximum quantization parameter value qₘₐₓ^{t-1}, according to qₘₐₓ^{t}=(1−η)max(T^{t-1})+ηqₘₐₓ^{t-1}, wherein η is a momentum parameter.

Clause 7: A method according to any one of Clauses 1-6, wherein the one or more quantization parameter values determined based on the current tensor comprise a quantization range computed based on a saturation ratio for quantizing the current tensor.

Clause 8: A method according to any one of Clauses 1-7, wherein the quantization range is updated based on one or more thresholds associated with the saturation ratio.

Clause 9: A method according to any one of Clauses 1-8, wherein: the one or more thresholds comprise a maximum saturation threshold Cₘₐₓ and a minimum saturation threshold Cₘᵢₙ, the quantization range is defined by a current quantization parameter value qₜ, and updating the quantization range is performed according to:

$${q}_{t} = λ {q}_{t} ; where λ = \{ \begin{matrix}{C}_{max} / {CDF}^{- 1} [ 1 - \frac{α}{2} ] & if α > {C}_{max} \\ 1 & if {C}_{min} < α \leq {C}_{max} \\ 1 - step & if α \leq {C}_{min}\end{matrix} ,$$

where CDF⁻¹ is an inverse cumulative distribution function, α is the saturation ratio, and step is a defined step value.

Clause 10: A method according to any one of Clauses 1-9, wherein the current tensor is a gradient tensor.

Clause 11: A method according to any one of Clauses 1-10, wherein the current tensor is an activation tensor.

Clause 12: A method, comprising: collecting activation data statistics while generating inferences using a trained neural network; determining one or more quantization parameter values based on the activation data statistics; and using the one or more quantization parameter values during a refinement operation for the trained neural network.

Clause 13: A method according to Clause 12, wherein the one or more quantization parameter values determined based on the activation data statistics are computed based on a minimum value and a maximum value of the activation data.

Clause 14: A method according to any one of Clauses 12-13, wherein the one or more quantization parameter values determined based on the activation data statistics are computed based on a standard deviation of the activation data.

Clause 15: A method according to any one of Clauses 12-14, wherein the one or more quantization parameter values determined based on the activation data statistics comprise a quantization range computed based on a saturation ratio for quantizing the activation data.

Clause 16: A method according to any one of Clauses 12-15, wherein the quantization range is updated based on one or more thresholds associated with the saturation ratio.

Clause 17: A method according to any one of Clauses 12-16, further comprising, during the refinement operation: generating a current tensor at a first bitwidth; determining one or more quantization parameter values based on the current tensor; and quantizing the current tensor to a lower bitwidth based on the one or more quantization parameter values determined based on the activation data statistics.

Clause 18: A system, comprising: a memory comprising computer-executable instructions; and one or more processors configured to execute the computer-executable instructions and cause the processing system to perform a method in accordance with any one of Clauses 1-17.

Clause 19: A system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for updating a neural network, comprising:
receiving a tensor at a layer of a neural network;
generating a current tensor at a first bitwidth based on the received tensor;
determining one or more quantization parameter values based on the current tensor; and
quantizing the current tensor to a lower bitwidth based on one or more quantization parameter values determined based on a previous tensor generated during updating of the neural network, wherein using the one or more quantization parameters determined based on the previous tensor reduces memory transfer needed to quantize the current tensor.

2. The method of claim 1, wherein the one or more quantization parameter values determined based on the current tensor are computed based on a minimum current tensor value and a maximum current tensor value.

3. The method of claim 1, wherein the one or more quantization parameter values determined based on the current tensor are computed based on a standard deviation of current tensor values.

4. The method of claim 1, further comprising:
storing the one or more quantization parameter values determined based on the current tensor in a memory for use in a subsequent tensor quantization; and
quantizing a subsequent tensor during a subsequent pass of data through the layer of the neural network based on the one or more quantization parameter values determined based on the current tensor.

5. The method of claim 1, wherein determining the one or more quantization parameter values based on the current tensor comprises determining a moving average of the one or more quantization parameter values based on the current tensor and the previous tensor.

6. The method of claim 5, wherein:
a current minimum quantization parameter value qₘᵢₙ^{t} is calculated as a moving average based on the previous tensor T^{t-1} and a previous minimum quantization parameter value qₘᵢₙ^{t-1}, according to qₘₐₓ^{t}=(1−η)min(T^{t-1})+ηqₘᵢₙ^{t-1}, and
a current maximum quantization parameter value qₘₐₓ^{t} is calculated as a moving average based on the previous tensor T^{t-1} and a previous maximum quantization parameter value qₘₐₓ^{t-1}, according to qₘₐₓ=(1−η)max(T^{t-1})+ηqₘₐₓ^{t-1}, wherein η is a momentum parameter.

7. The method of claim 1, wherein the one or more quantization parameter values determined based on the current tensor comprise a quantization range computed based on a saturation ratio for quantizing the current tensor.

8. The method of claim 7, wherein the quantization range is updated based on one or more thresholds associated with the saturation ratio.

9. The method of claim 8, wherein:
the one or more thresholds comprise a maximum saturation threshold Cₘₐₓ and a minimum saturation threshold Cₘᵢₙ,
the quantization range is defined by a current quantization parameter value qₜ, and
updating the quantization range is performed according to
$${q}_{t} = λ {q}_{t} , wherein λ = \{ \begin{matrix}{C}_{max} / {CDF}^{- 1} [ 1 - \frac{α}{2} ] & if α > {C}_{max} \\ 1 & if {C}_{min} < α \leq {C}_{max} \\ 1 - step & if α \leq {C}_{min}\end{matrix} ,$$
and wherein where CDF⁻¹ is an inverse cumulative distribution function, α is the saturation ratio, and step is a defined step value.

10. The method of claim 1, wherein the current tensor is a gradient tensor.

11. The method of claim 1, wherein the current tensor is an activation tensor.

12. A computer-implemented method, comprising:
collecting activation data statistics while generating inferences using a trained neural network;
determining one or more quantization parameter values based on the activation data statistics; and
using the one or more quantization parameter values during a refinement operation for the trained neural network.

13. The method of claim 12, wherein the one or more quantization parameter values determined based on the activation data statistics are computed based on a minimum value and a maximum value of activation data.

14. The method of claim 12, wherein the one or more quantization parameter values determined based on the activation data statistics are computed based on a standard deviation of activation data.

15. The method of claim 12, wherein the one or more quantization parameter values determined based on the activation data statistics comprise a quantization range computed based on a saturation ratio for quantizing activation data.

16. The method of claim 15, wherein the quantization range is updated based on one or more thresholds associated with the saturation ratio.

17. The method of claim 12, further comprising, during the refinement operation:
generating a current tensor at a first bitwidth;
determining one or more quantization parameter values based on the current tensor; and
quantizing the current tensor to a lower bitwidth based on the one or more quantization parameter values determined based on the activation data statistics.

18. A processing system, comprising:
a memory comprising computer-executable instructions; and
one or more processors configured to execute the computer-executable instructions and cause the processing system to perform an operation comprising:
receiving a tensor at a layer of a neural network;
generating a current tensor at a first bitwidth based on the received tensor;
determining one or more quantization parameter values based on the current tensor; and
quantizing the current tensor to a lower bitwidth based on one or more quantization parameter values determined based on a previous tensor generated during updating of a neural network, wherein using the one or more quantization parameters determined based on the previous tensor reduces memory transfer needed to quantize the current tensor.

19. The processing system of claim 18, wherein the one or more quantization parameter values determined based on the current tensor are computed based on a minimum current tensor value and a maximum current tensor value.

20. The processing system of claim 18, wherein the one or more quantization parameter values determined based on the current tensor are computed based on a standard deviation of current tensor values.

21. The processing system of claim 18, the operation further comprising:
storing the one or more quantization parameter values determined based on the current tensor in a memory for use in a subsequent tensor quantization; and
quantizing a subsequent tensor during a subsequent pass of data through the layer of the neural network based on the one or more quantization parameter values determined based on the current tensor.

22. The processing system of claim 18, wherein determining the one or more quantization parameter values based on the current tensor comprises determining a moving average of the one or more quantization parameter values based on the current tensor and the previous tensor.

23. The processing system of claim 18, wherein the one or more quantization parameter values determined based on the current tensor comprise a quantization range computed based on a saturation ratio for quantizing the current tensor.

24. The processing system of claim 23, wherein the quantization range is updated based on one or more thresholds associated with the saturation ratio.

25. A processing system, comprising:
a memory comprising computer-executable instructions; and
one or more processors configured to execute the computer-executable instructions and cause the processing system to perform an operation comprising:
collecting activation data statistics while generating inferences using a trained neural network;
determining one or more quantization parameter values based on the activation data statistics; and
using the one or more quantization parameter values during a refinement operation for the trained neural network.

26. The processing system of claim 25, wherein the one or more quantization parameter values determined based on the activation data statistics are computed based on a minimum value and a maximum value of activation data.

27. The processing system of claim 25, wherein the one or more quantization parameter values determined based on the activation data statistics are computed based on a standard deviation of activation data.

28. The processing system of claim 25, wherein the one or more quantization parameter values determined based on the activation data statistics comprise a quantization range computed based on a saturation ratio for quantizing activation data.

29. The processing system of claim 28, wherein the quantization range is updated based on one or more thresholds associated with the saturation ratio.

30. The processing system of claim 25, the operation further comprising, during the refinement operation:
generating a current tensor at a first bitwidth;
determining one or more quantization parameter values based on the current tensor; and
quantizing the current tensor to a lower bitwidth based on the one or more quantization parameter values determined based on the activation data statistics.
